(19) United States
(12) Patent Application Publication
(10) Pub. No.: US 2014/0033823 A1
(43) Pub. Date: Feb. 6, 2014

(54) ANNULAR SEISMIC SENSOR NODE

(71) Applicant: Harry George Dennis Gosling, Bristol (GB)

(72) Inventor: Harry George Dennis Gosling, Bristol (GB)

(73) Assignee: GO SCIENCE LIMITED, Bristol (GB)

(21) Appl. No.: 13/985,323

(22) PCT Filed: Feb. 8, 2012
(86) PCT No.: PCT/GB2012/050279

§ 371 Date: Oct. 15, 2013

(30) Foreign Application Priority Data
Feb. 15, 2011 (GB) 1102577.2

(51) Int. Cl. G01H 1/00

(52) U.S. Cl. CPC G01H 1/00
USPC 73/649

(57) ABSTRACT

A seismic sensor node comprising an annular body (2) with an annular cutting edge (3) at one end. One or more seismic sensors (8, 9) are coupled to the annular body (2). The annular body (2) surrounds a duct (5) which is open at either end to permit liquid to flow through the duct, and which increases in cross-sectional area as it extends towards the cutting edge (3). The compression of the seabed material squeezes out water from the material, making it more dense so that it transmit seismic vibrations more efficiently. The shape of the duct (5) also means that the centre of gravity of the node is lower than it would be for a cylindrical node—thus increasing the stability of the node compared with a cylindrical one.

### FIELD OF THE INVENTION

The present invention relates to a seismic sensor node and a method of acquiring seismic data.

### BACKGROUND OF THE INVENTION

A known seismic sensor node is described in EP 1674888 A2. Each sensor unit is held by a carrier and connected to a cylindrical skirt with a serrated cutting edge.

### SUMMARY OF THE INVENTION

A first aspect of the invention provides a seismic sensor node comprising an annular body with an annular cutting edge at one end; and one or more seismic sensors coupled to the annular body, wherein the annular body surrounds a duct which is open at either end to permit liquid to flow through the duct, and which increases in cross-sectional area as it extends towards the cutting edge.

A second aspect of the invention provides a method of acquiring seismic data with the seismic sensor node of the first aspect, the method comprising embedding the cutting edge at least partially into the seabed so that seabed material passes into the duct and is compressed inwardly by the walls of the duct; and acquiring seismic data from the seabed with the seismic sensor(s).

The compression of the seabed material squeezes out water from the material, making it more dense so that it transmit seismic vibrations more efficiently. The shape of the duct also means that the centre of gravity of the node is lower than it would be for a cylindrical node—thus increasing the stability of the node compared with a cylindrical one.

Typically the duct has a first end adjacent to the cutting edge and a second end remote from the cutting edge, and the cross-sectional area of the first end of the duct is greater than the cross-sectional area of the second end of the duct.

The one or more seismic sensors typically comprise a seismic sensor which is mounted within the duct by two or more struts. Optionally a second seismic sensor may be carried by the annular body outside the duct.

Typically at least part of the duct is substantially circular in cross-section.

The one or more seismic sensors may comprise a geophone. Optionally a hydrophone may also be provided.

Typically the cutting edge is serrated.

Typically the annular body comprises an annular support frame which carries the seismic sensor(s); and an annular skirt which is attached to the annular support frame and provides the annular cutting edge. The duct may be defined by the skirt, by the frame, or by both the skirt and the frame.

The duct typically tapers outwardly as it extends towards the cutting edge. It may taper throughout its length, or through only part of its length.

### BRIEF DESCRIPTION OF THE DRAWINGS

Embodiments of the invention will now be described with reference to the accompanying drawings, in which:

FIG. 1 is a perspective view of a seismic sensor node;

FIG. 2 is a vertical sectional view of the sensor node;

FIG. 3 is a bottom view of the sensor node;

FIG. 4 is a plan view of the sensor node;

FIG. 5 is a plan view of the sensor node with the hydrophone and its support frame removed;

FIG. 6 is a perspective view of a seismic sensor node according to a second embodiment of the invention;

FIG. 7 is a bottom view of the node of FIG. 6;

FIG. 8 is a perspective view of a seismic sensor node according to a third embodiment of the invention; and

FIG. 9 is a plan view of the skirt of the node of FIG. 8.

### DETAILED DESCRIPTION OF EMBODIMENT(S)

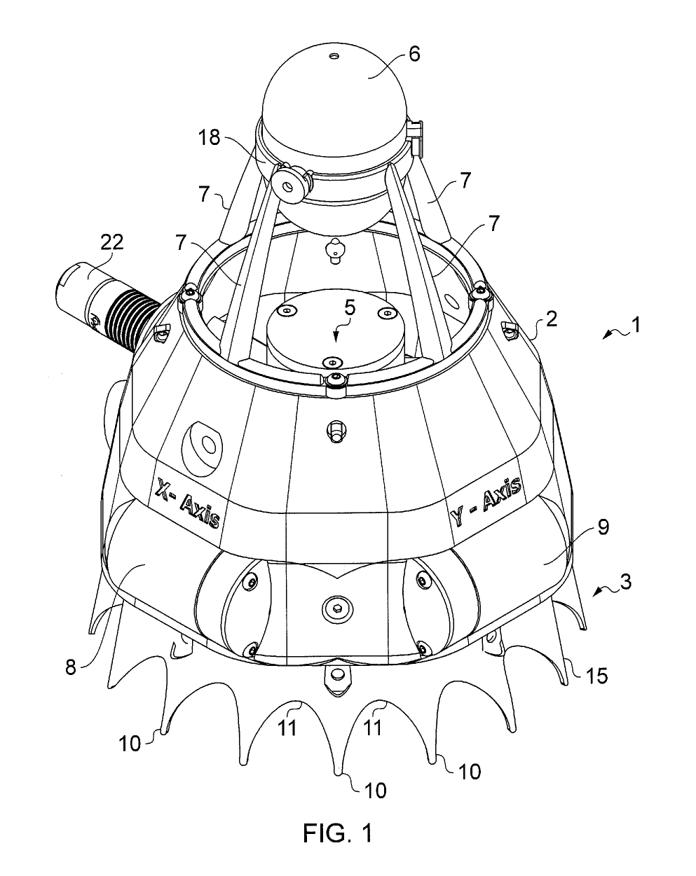

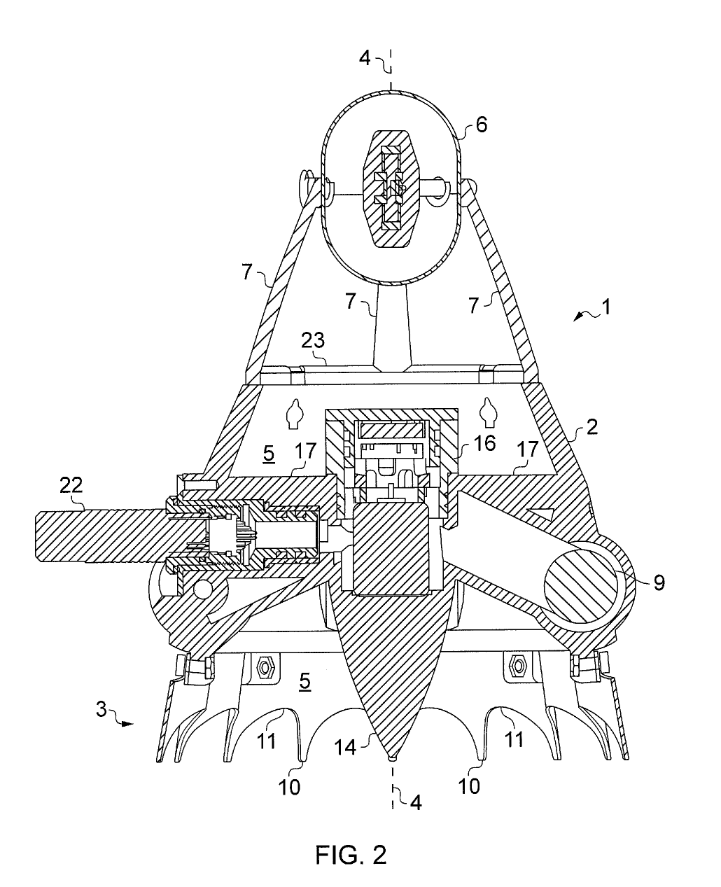

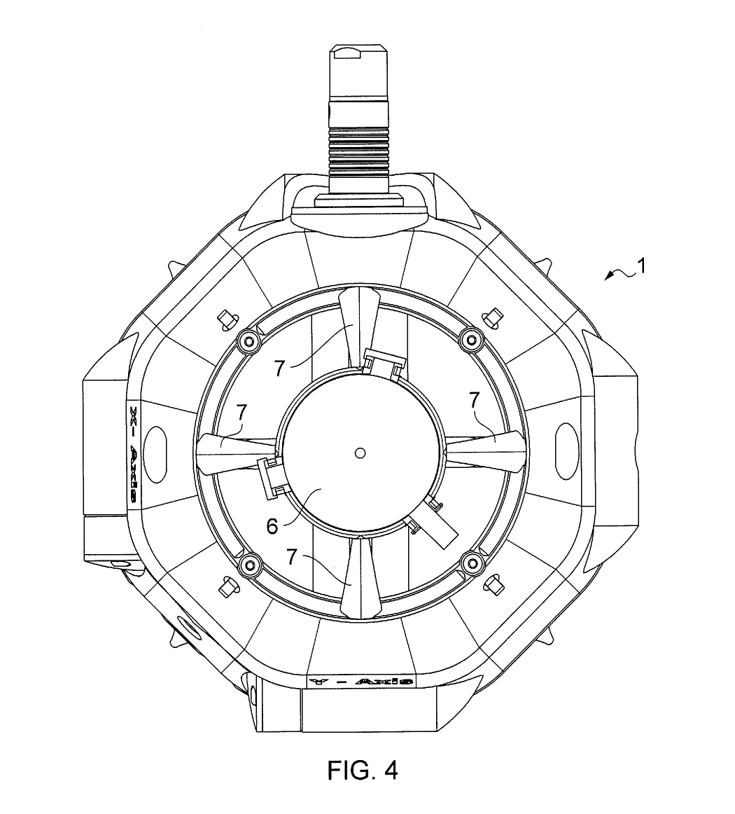

A seismic sensor node 1 shown in FIGS. 1-5 comprises an annular support frame 2 carrying an annular skirt 3 at its lower edge. The support frame 2 and the skirt 3 together define a central annular axis 4 (shown in FIG. 2) and surround a duct 5 which is open at both its upper and lower ends to permit liquid to flow through the duct. As can be seen in FIG. 2, the duct 5 is flared so that it increases in cross-sectional area as it extends towards the cutting edge of the skirt 3.

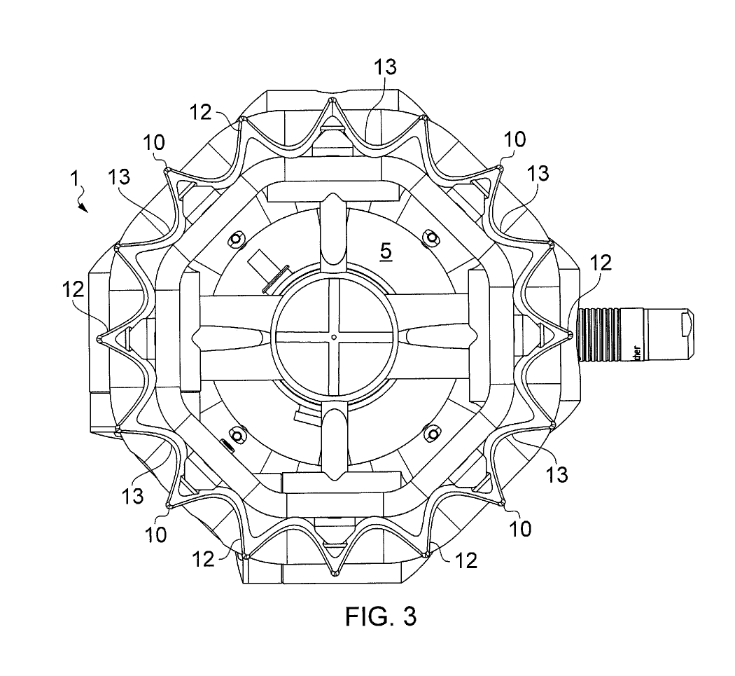

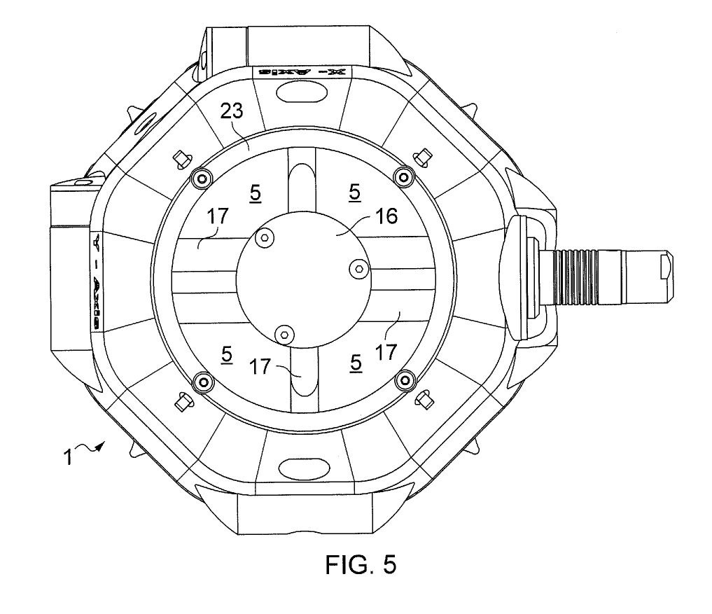

The duct has a first (lower) end adjacent to the skirt 3 and a second (upper) end remote from the skirt 3. A comparison of FIG. 3 with FIG. 5 shows that the cross-sectional area of the first end of the duct (as defined by the skirt 3) is over twice the size of the cross-sectional area of the second end of the duct (as defined by the upper edge 23 of the support frame 2). The diameter of the skirt 3 is of the order of 13-15 cm (5-6 inches).

A Z-axis geophone sensor 16 is mounted within the duct 5 by four struts 17. An X-axis geophone sensor 8 and a Y-axis geophone sensor 9 are carried by the annular body 2 outside the duct 5. In an alternative embodiment (not shown) the X and Y geophone sensors may be mounted on struts within the duct as well as the Z-axis geophone sensor 16. The struts 17 also carry a pair of accelerometers (not shown) which measure the angle of inclination of the node to the vertical.

The skirt 3 tapers or flares outwardly towards a cutting edge at its lower periphery. The cutting edge appears as a series of inwardly tapering teeth with points 10 when viewed from the side at a right angle to the annular axis as shown in FIGS. 1 and 2. The cutting edge has a curved notch 11 between each adjacent pair of teeth.

The skirt also has a series of ribs 12 and channels 13 which run towards the cutting edge and terminate at the cutting edge so that the cutting edge has an undulating shape when viewed from below parallel with the annular axis as shown in FIG. 3. Each of the ribs 12 terminates in a respective one of the teeth 10 at its lower edge. Each rib 12 tapers inwardly to a ridge 15 which runs away from the cutting edge, and the channels 13 appear curved when viewed from below as shown in FIG. 3, providing a focusing effect on shear wave seismic energy.

A ring 18 with four struts 7 is mounted to the upper edge of the support frame 2. The ring 18 carries a hydrophone sensor 6.

A data port 22 is connected to the geophones 16,8,9 and the hydrophone 6. A cable (not shown) can be connected to the data port 22 to transmit data to/from the sensors.

When in use, the skirt 3 is embedded at least partially into the seabed so that seabed material passes into the duct 5. Since the duct has a larger cross-sectional area towards the cutting edge at its base, the seabed material is compressed inwardly by the tapered frustoconical walls of the duct 5 as it passes through the duct. The tapered shape of the duct also means that the centre of gravity of the node is lower than it would be for a cylindrical node—thus increasing the stability of the node compared with a cylindrical one. Seismic data can then be acquired with the seismic sensors 16,8,9,6.

Shear waves are transmitted to the geophones 16,8,9 by the compressed seabed material, and also by the skirt 3 and support frame 2. The undulating shape of the skirt makes it particularly resistant to ellipsoid or modal oscillation, so that it can transmit shear waves to the geophones with minimal distortion, attenuation or damping. Also, the compression of the seabed material squeezes out water from the material, making it more dense so that it transmits the shear waves more efficiently.

A spike 14 extends down from the geophone 16 to a point which lies in the same plane as the points 10 of the teeth. The spike 14 penetrates the seabed along with the skirt 3 and transmits shear waves to the geophone 16. Pressure waves are sensed by the hydrophone 6.

The sensor node may be towed to and from the seabed on a flexible tether attached to the ring 18, dropped from above the seabed so it sinks down, or deployed by a robotic arm from the rear of an underwater vehicle. In the first two cases, water flows through the duct 5 as the sensor passes through the water. In this case the ribs 12 and channels 13 provide hydrodynamic benefits in that they act as so-called “bluff grooves” which enable the node to fly well at low speeds and make it more stable in roll.

The node 1 is negatively buoyant with a weight in water of the order of 0.5-1.1 kg. This helps to compress the seabed material passing through the duct and encourages positive coupling of seismic energy with the sensors.

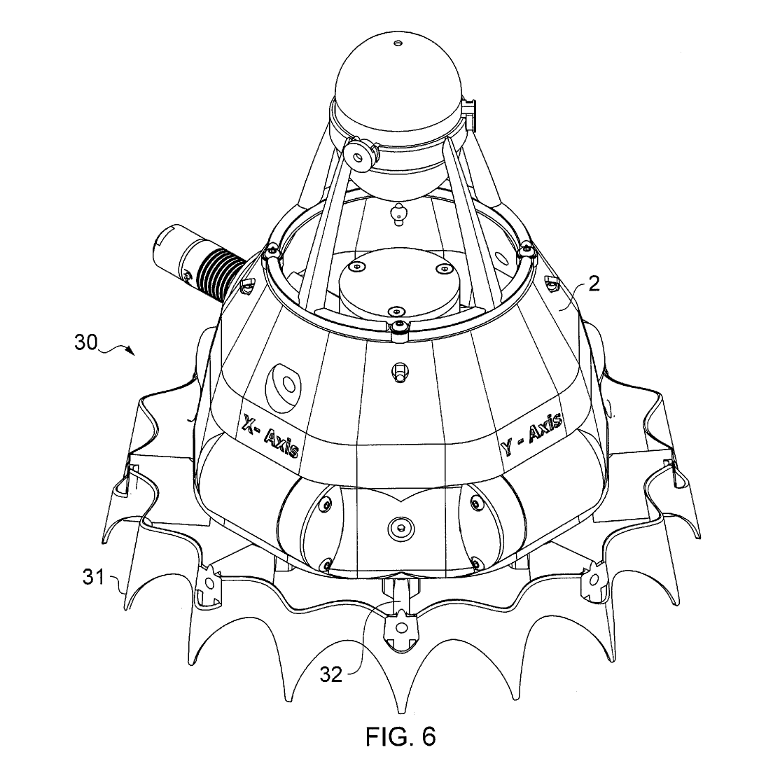

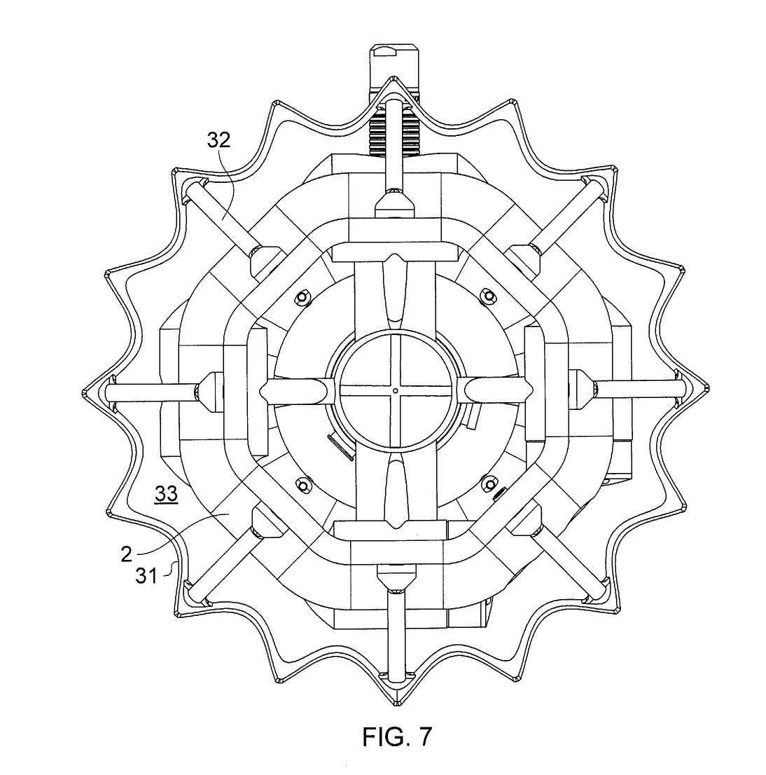

FIGS. 6 and 7 show a seismic sensor node 30 according to a second embodiment of the invention, in which the skirt 3 is replaced by a wider skirt 31 which is wider at both ends than the base of the frame 2. The skirt 31 is mounted to the base of the frame 2 by eight struts (one of which is labelled 32 in FIGS. 6 and 7) leaving an open slot 33 between the frame 2 and the skirt 31. The larger skirt 31 increases the coupling area of the skirt, and makes the node more likely to orient itself vertically.

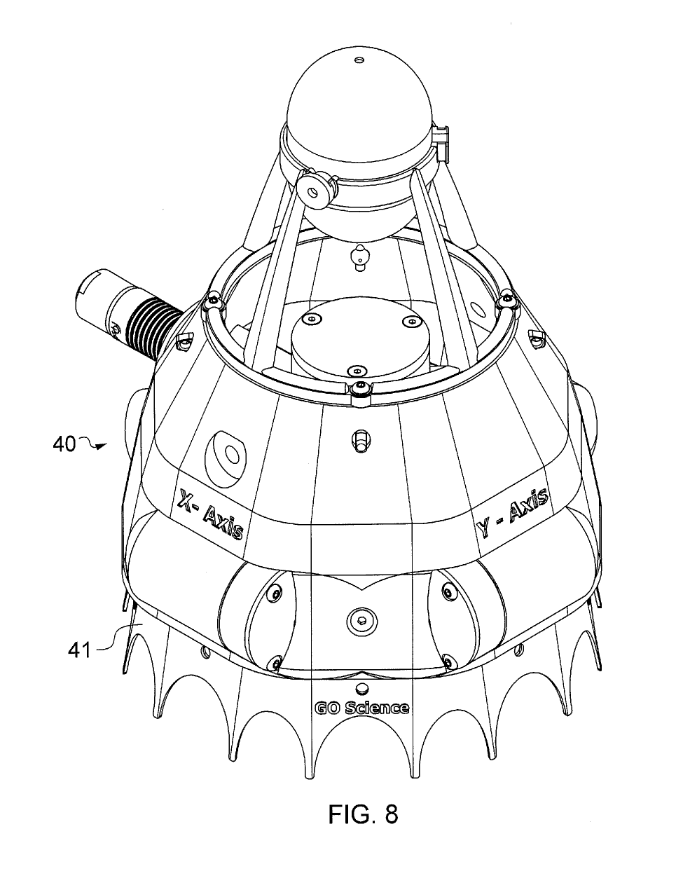

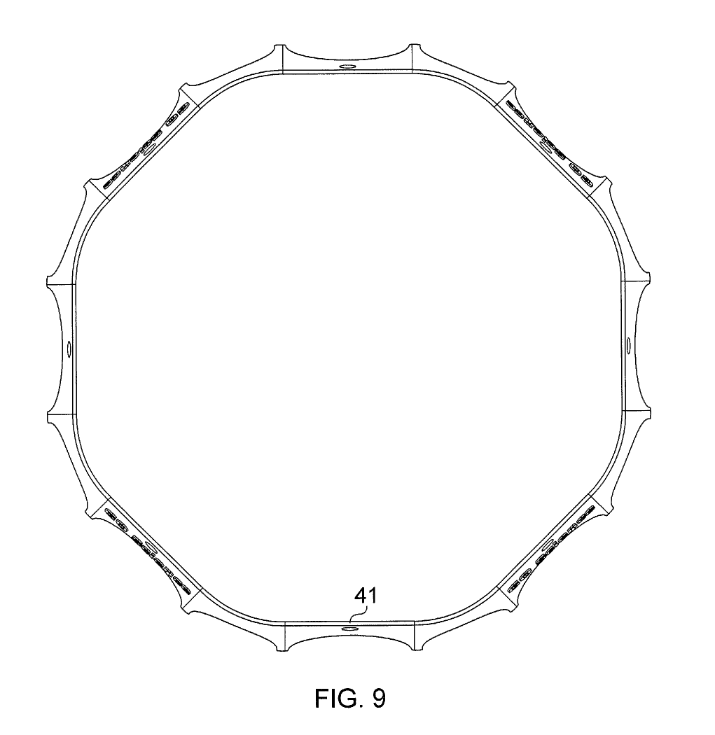

FIGS. 8 and 9 show a seismic sensor node 40 according to a third embodiment of the invention, in which the skirt 3 is replaced by a skirt 41. The skirt 41 is similar to the skirt 3 in that it increases in cross-sectional area as it extends towards the cutting edge, but it lacks the ribs and grooves so it does not have an undulating shape when viewed from above parallel with the annular axis as shown in FIG. 9.

Although the invention has been described above with reference to one or more preferred embodiments, it will be appreciated that various changes or modifications may be made without departing from the scope of the invention as defined in the appended claims.

1. A seismic sensor node comprising an annular body with an annular cutting edge at one end; and one or more seismic sensors coupled to the annular body, wherein the annular body surrounds a duct which is open at either end to permit liquid to flow through the duct, and which increases in cross-sectional area as it extends towards the cutting edge.

2. The node of claim 1 wherein the duct has a first end adjacent to the cutting edge and a second end remote from the cutting edge, and wherein the cross-sectional area of the first end of the duct is greater than the cross-sectional area of the second end of the duct.

3. The node of claim 1 wherein the one or more seismic sensors comprise a seismic sensor which is mounted within the duct by two or more struts.

4. The node of claim 3 wherein the one or more seismic sensors comprise a first seismic sensor mounted within the duct by two or more struts; and a second seismic sensor carried by the annular body outside the duct.

5. The node of claim 1 wherein at least part of the duct is substantially circular in cross-section.

6. The node of claim 1 wherein the one or more seismic sensors comprises a geophone

7. The node of claim 1 wherein the cutting edge is serrated.

8. The node of claim 1 wherein the annular body comprises an annular support frame which carries the seismic sensor(s); and an annular skirt which is attached to the annular support frame and provides the annular cutting edge.

9. The node of claim 8 wherein the duct which is open at either end to permit liquid to flow through the duct, and which increases in cross-sectional area as it extends towards the cutting edge, is defined at least partially by the skirt.

10. The node of claim 8 wherein the duct which is open at either end to permit liquid to flow through the duct, and which increases in cross-sectional area as it extends towards the cutting edge, is defined at least partially by the annular support frame.

11. The node of claim 8 wherein the skirt is wider at both ends than the base of the frame, and is mounted to the base of the frame by struts leaving an open slot between the frame and the skirt.

12. The node of claim 1 wherein the duct tapers outwardly as it extends towards the cutting edge.

13. A method of acquiring seismic data with the seismic sensor node of claim 1, the method comprising embedding the cutting edge at least partially into the seabed so that seabed material passes into the duct and is compressed inwardly by the walls of the duct; and acquiring seismic data from the seabed with the seismic sensor(s).
